(19) United States
(12) Patent Application Publication
(10) Pub. No.: US 2026/0351005 A1
(43) Pub. Date: Nov. 5, 2026

(54) A-SYNCHRONOUS ASSOCIATION FOR PARKING SLOT MEASUREMENTS

(71) Applicant: GM GLOBAL TECHNOLOGY OPERATIONS LLC, Detrolt, MI (US)

(72) Inventors: Dan LEVI, Ganei Tikvah (IL); Yotam KRAMER, Hod Hasharon (IL); Matan YEGER, Pardes Hanna-Karkur (IL); Lior BARAK, Binyamina (IL); Elad FARHI, Atlit (IL)

(21) Appl. No.: 19/194,253

(22) Filed: Apr. 30, 2025

(51) Int. Cl. G06V 20/58; G06V 10/40; G06V 10/74; G06V 10/75; G06V 10/762

(52) U.S. Cl. CPC G06V 20/586; G06V 10/40; G06V 10/751; G06V 10/761; G06V 10/762

(57) ABSTRACT

A vision-based perception system for a vehicle includes N cameras arranged on the vehicle and configured to generate a plurality of images, where N is an integer greater than one. An image analysis module is configured to identify a plurality of features of parking slots in the plurality of images and to generate a plurality of keyframe measurements based thereon. A keyframe selecting module is configured to identify selected ones of the plurality of keyframe measurements. A database is configured to receive the selected ones of the plurality of keyframe measurements and to selectively output unassociated keyframe measurements and existing features of parking slots within a predetermined range of the vehicle. A data association module is configured to receive the unassociated keyframe measurements and the existing features of parking slots from the database.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vision-based systems for vehicles, and more particularly to parking slot location and mapping systems for autonomous driving systems.

Vehicles may include autonomous driving systems that operate the vehicle without driver input. The autonomous driving systems receives images from multiple cameras pointed in different directions. For example, the vehicle may include one or more forward facing cameras, one or more side facing cameras, and one or more rear facing cameras. Autonomous driving systems need to be able to sense the location of open parking slots in a parking lot. The autonomous driving system may not know the locations of the parking slots in the parking lot before arriving at the parking lot and/or whether each of the parking slots are currently occupied. The autonomous driving system uses the images generated by the cameras while driving through the parking lot to determine the locations of available parking slots and then parks the vehicle in one of the available parking slots.

### SUMMARY

A vision-based perception system for a vehicle includes N cameras arranged on the vehicle and configured to generate a plurality of images, where N is an integer greater than one. An image analysis module is configured to identify a plurality of features of parking slots in the plurality of images and to generate a plurality of keyframe measurements based thereon. A keyframe selecting module is configured to identify selected ones of the plurality of keyframe measurements. A database is configured to receive the selected ones of the plurality of keyframe measurements and to selectively output unassociated keyframe measurements and existing features of parking slots within a predetermined range of the vehicle. A data association module is configured to receive the unassociated keyframe measurements and the existing features of parking slots from the database.

In other features, at least two of the unassociated keyframe measurements and the existing features of parking slots are a-synchronous measurements. The data association module is configured to selectively associate selected ones of the keyframe measurements to existing features of parking slots and other selected ones of the keyframe measurements to new features of parking slots.

In other features, the data association module is configured to generate measurements between the unassociated keyframe measurements and the existing features of parking slots, identify inter-measurement associations, and identify inter-landmark associations.

In other features, the data association module is configured to generate measurements between the unassociated keyframe measurements and the existing features of parking slots by transforming features of parking slots of the unassociated keyframe measurements to a local frame and calculating a distance to the existing features of parking slots.

In other features, when the distance is less than a predetermined distance, the data association module is configured to define a distinct association between a corresponding one of the unassociated keyframe measurements and a corresponding one of the existing features of parking slots. The data association module is configured to identify inter-measurement associations by calculating distances between the unassociated keyframe measurements and clustering the unassociated keyframe measurements based on the distances into one or more clusters.

In other features, the data association module is configured to identify inter-measurement associations by selecting one of the one or more clusters, calculating an initial estimate for a parking slot corresponding to the one of the one or more clusters, adding the parking slot to the database, and repeating the calculating and adding for remaining ones of the one or more clusters.

In other features, the data association module is configured to identify inter-landmark associations by retrieving existing neighbor associations, retrieving relevant parking slots from the database, selecting a candidate parking slot, and determining whether orientations of neighbor parking slots match the candidate parking slot.

In other features, the data association module is configured to identify inter-landmark associations by selecting a best candidate from two or more candidates as a neighbor if the candidate parking slot does not already have a neighboring parking slot in a predetermined neighbor location, updating association links in the database, and repeating the selecting and updating for other candidate parking slots.

In other features, the data association module is configured to select the best candidate from the two or more candidates based on distances between the two or more candidates and the candidate parking slot.

A method for identifying and associating parking slots includes generating a plurality of images using N cameras arranged on a vehicle, where N is an integer greater than one; identifying a plurality of features of parking slots in the plurality of images and to generating a plurality of keyframe measurements based thereon; identifying selected ones of the plurality of keyframe measurements; storing the selected ones of the plurality of keyframe measurements in a database; selecting unassociated keyframe measurements and existing features of parking slots within a predetermined range of the vehicle from the database; and selectively associating selected ones of the keyframe measurements to existing features of parking slots and other selected ones of the keyframe measurements to new features of parking slots. At least two of the unassociated keyframe measurements and the existing features of parking slots are a-synchronous measurements.

In other features, selectively associating selected ones of the keyframe measurements to existing features of parking slots and other selected ones of the keyframe measurements to new features of parking slots includes generating measurements between the unassociated keyframe measurements and the existing features of parking slots; identifying inter-measurement associations; and identifying inter-landmark associations.

In other features, generating measurements between the unassociated keyframe measurements and the existing features of parking slots includes transforming features of parking slots of the unassociated keyframe measurements to a local frame and calculating a distance to the existing features of parking slots. When the distance is less than a predetermined distance, the method includes defining a distinct association between a corresponding one of the unassociated keyframe measurements and a corresponding one of the existing features of parking slots.

In other features, identifying the inter-measurement associations includes calculating distances between the unassociated keyframe measurements; and clustering the unassociated keyframe measurements based on the distances into one or more clusters.

In other features, performing inter-measurement associations includes selecting one of the one or more clusters; calculating an initial estimate for a parking slot corresponding to the one of the one or more clusters; adding the parking slot to the database; and repeating the calculating and adding for remaining ones of the one or more clusters.

In other features, identifying inter-landmark associations includes retrieving existing neighbor associations; retrieving relevant parking slots from the database; selecting a candidate parking slot; and determining whether orientations of neighbor parking slots match the candidate parking slot.

In other features, identifying inter-landmark associations includes selecting a best candidate from two or more candidates as a neighbor if the candidate parking slot does not already have a neighboring parking slot in a predetermined neighbor location; updating association links in the database; and repeating the selecting and updating for other candidate parking slots.

A vision-based perception system for a vehicle includes N cameras arranged on the vehicle and configured to generate a plurality of images, where N is an integer greater than one. An image analysis module is configured to identify a plurality of features of parking slots in the plurality of images and to generate a plurality of keyframe measurements based thereon. A keyframe selecting module is configured to identify selected ones of the plurality of keyframe measurements. A database is configured to receive the selected ones of the plurality of keyframe measurements and to selectively output unassociated keyframe measurements and existing features of parking slots within a predetermined range of the vehicle. A data association module is configured to receive the unassociated keyframe measurements and the existing features of parking slots from the database. At least two of the unassociated keyframe measurements and the existing features of parking slots are a-synchronous measurements. The data association module is configured to selectively associate selected ones of the keyframe measurements to existing features of parking slots and other selected ones of the keyframe measurements to new features of parking slots. The data association module is configured to generate measurements between the unassociated keyframe measurements and the existing features of parking slots, identify inter-measurement associations, and identify inter-landmark associations.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including a vision-based parking slot location module configured to map and localize parking slots in a parking lot according to the present disclosure;

FIG. 2A is a plan view of an example of a vehicle passing through a parking lot with parking slots and parking in one of the parking slots according to the present disclosure;

FIG. 2B illustrates a vehicle in a parking slot according to the present disclosure;

FIG. 3 is a functional block diagram of an example of a parking slot location module according to the present disclosure;

FIGS. 4 and 5A are flowcharts of examples of methods for identifying parking slots in a parking lot according to the present disclosure;

FIG. 5B illustrates an example of a comparison of parking slot centers to centers of existing parking slots according to the present disclosure; and

FIGS. 5C to 10 are flowcharts of examples of methods for identifying parking slots in a parking lot according to the present disclosure.

In the drawings, reference numbers may be reused to identify similar and/or identical elements.

### DETAILED DESCRIPTION

Autonomous driving systems rely on vision-based systems including multiple cameras. Associations based on measurements made by the cameras require synchronizing the cameras to achieve optimal performance. In addition, multi-frame associations require saving incomplete calculations and aggregating the data until a stable solution is reached. Other issues include odometry drift which may cause straight lines to become slowly curved, which deforms the sensed representation of the environment.

The present disclosure relates to systems and method for generating associations between multi-camera, multi-frame measurements without the need for explicit synchronization using a database and global a-synchronous queries. The retrieved measurements are associated to each other using a cluster algorithm, and to pre-existing landmarks using a one-to-many approach with robust outlier rejection.

Parking slots are semantic-less. In other words, all objects in each location look similar or the same. Detector noise and odometry drift may cause a straight parking lane to appear curved. The systems and methods described herein use prior knowledge of the structure of parking slots and parking lots to improve accuracy. The systems and methods described herein allow synchronization between different cameras without adding latency or forcing hardware synchronization.

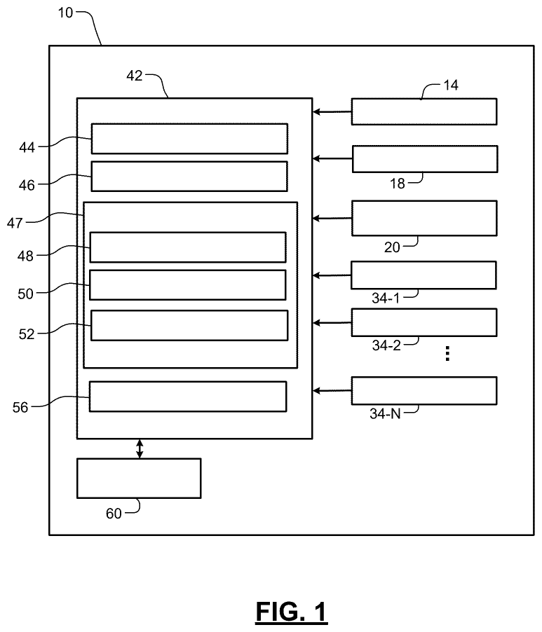

Referring now to FIG. 1, a vehicle 10 includes various sensors such as a global positioning system (GPS) 14, an inertial measurement unit (IMU) 18, and wheel speed sensors 20. The vehicle 10 includes one or more cameras 34-1, 34-2, . . . , and 34-N that generate images in forward, side, and rear directions relative to the vehicle 10, wherein N is an integer greater than one. In some examples, the cameras 34-1, 34-2, . . . , and 34-N include one or more forward-facing cameras, one or more side-facing cameras, and one or more rear-facing cameras.

A controller 42 includes an image analysis module 44 configured to receive the images from the cameras 34-1, 34-2, . . . , and 34-N, to identify landmarks or parking slot features (e.g., corners or centers of parking slots) in the images and to generate keyframe measurements from the corresponding camera to the landmarks in the images. In some examples, the image analysis module 44 may include a neural network configured to identify various objects such as corners of parking slots.

A keyframe selecting module 46 selects keyframe measurements (each with a timestamp) from the images. The cameras 34-1, 34-2, . . . , and 34-N generate a lot of samples and not all of the samples provide new or useful information. For example, the measurements may or may not change significantly in subsequent keyframes during sequential timestamps when the vehicle is stationary or travelling slowly. Not all of the images will include parking slots. The keyframe selecting module 46 is configured to select some or all of the keyframes depending upon the value of the data.

A simultaneous localization and mapping (SLAM) module 47 is configured to perform simultaneous localization and mapping. In some examples, the SLAM module 47 includes Georgia Tech smoothing and mapping (GTSAM) or g2o modules, although other SLAM modules can be used.

The SLAM module 47 includes a data association module 48 that is configured to receive keyframes and to associate the keyframes with either existing states (e.g., parking slots that were already identified) or new states (e.g., new parking slots that were not previously identified).

In some examples, an optimization module 52 is configured to manage and optimize SLAM states (e.g., vehicle locations and locations of parking slot features). In some examples, the SLAM states correspond to vehicle and/or camera locations and parking slot features such as corners or centers of parking slots. In some examples, the optimization module 52 includes a cost function that is extended with parking slot/lot specific factors. Examples of parking slot/lot factors include most parking slots are quadrilateral, opposite sides of the parking slot are typically equal in length, opposite sides are generally parallel, most are generally rectangular, neighboring slots generally have similar dimensions, neighboring slots are generally co-parallel, etc. Additional details relating to extension of the optimization module 52 with parking slot factors can be found in commonly-assigned U.S. patent application Ser. No. xx/xxx,xxx (Attorney Docket No. P110856), entitled “Optimization System for Mapping Parking Slots Using Simultaneous Localization and Mapping”, which is hereby incorporated by reference in its entirety.

In some examples, the SLAM module 47 further includes a scale estimating module 50 configured to estimate a scale of measurements on a per camera and/or per measurement basis. Additional details relating to the scale estimating module 50 can be found in U.S. patent application Ser. No. xx/xxx,xxx (Attorney Docket No. P110844), entitled “Incremental Scale Estimation for Vision-Based Autonomous Driving Systems”, which is hereby incorporated by reference in its entirety.

The vehicle 10 includes an autonomous driving module 56 configured to control actuators 60 to adjust steering, braking, and/or acceleration of the vehicle 10. For example, the autonomous driving module 56 may park the vehicle in one of the parking slots that is identified and mapped.

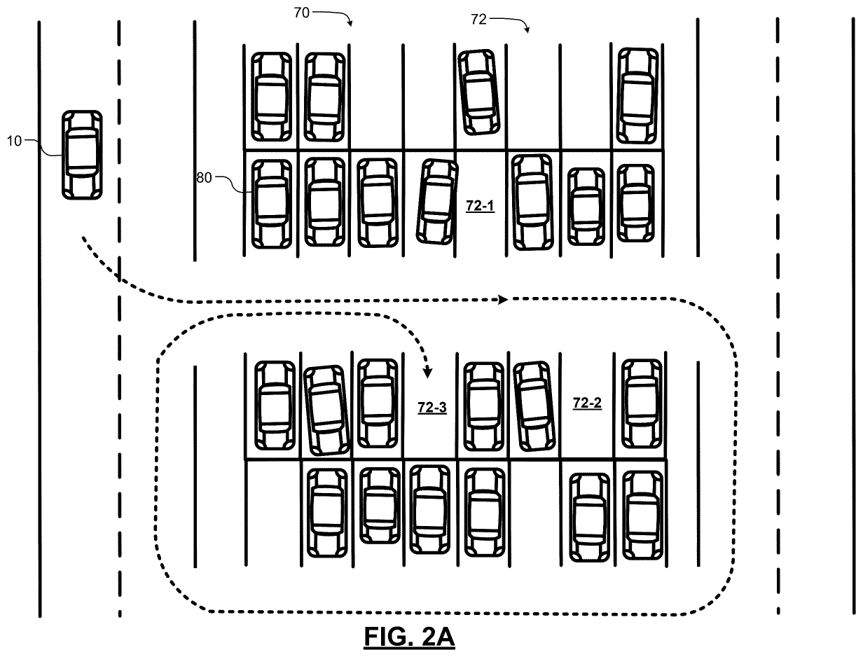

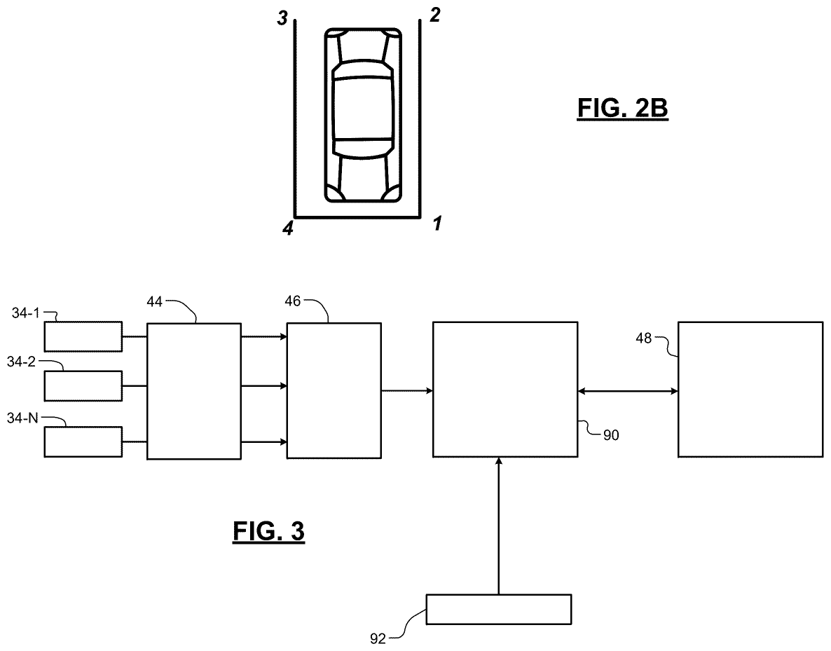

Referring now to FIG. 2A, the vehicle 10 enters a parking lot 70 including plurality of parking slots 72. The vehicle 10 generates images using the cameras 34-1, 34-2, . . . , and 34-N. Some of the images are selected as keyframes. Some of the selected keyframes may include parking slots that are identified by parking slot features such as centers or corner locations. The keyframes include locations of the corners of one or more parking slots at a given timestamp. In some examples, the keyframes are generated by one camera (such as parking slots located on one side of the vehicle 10). In some examples, the keyframes for a given timestamp can be generated by cameras on both sides of the vehicle, the front camera, and/or the rear camera.

Some of the parking slots 72 are occupied by vehicles 80 and others of the parking slots 72 are open. The vehicle 10 may proceed directly to one of the parking slots 72 such as parking slot 72-1 or parking slot 72-2 or the vehicle 10 may drive around the parking lot 70 before selecting one of the parking slots such as parking slot 72-3.

Referring now to FIG. 2B, an example of a parking slot including corners 1, 2, 3, and 4 is shown. In some examples, the locations of the corners 2, 3 may be detected (with high confidence and low covariance) and the corners 1, 4 may be estimated (with lower confidence and higher covariance) due to the position of the vehicle being closer to corners 2, 3.

Referring now to FIG. 3, the cameras 34-1, 34-2, . . . , and 34-N output images to the image analysis module 44. The image analysis module 44 outputs keyframes to a keyframe selection module 46 that selects some of the keyframes for further analysis. The selected keyframes are stored in a database 90, such as a structured query language (SQL) database, along with odometry/IMU data 92.

The data association module 48 is configured to determine whether the measurements (e.g., corner locations of parking slots) correspond to existing parking slots or new parking slots as will be described further below.

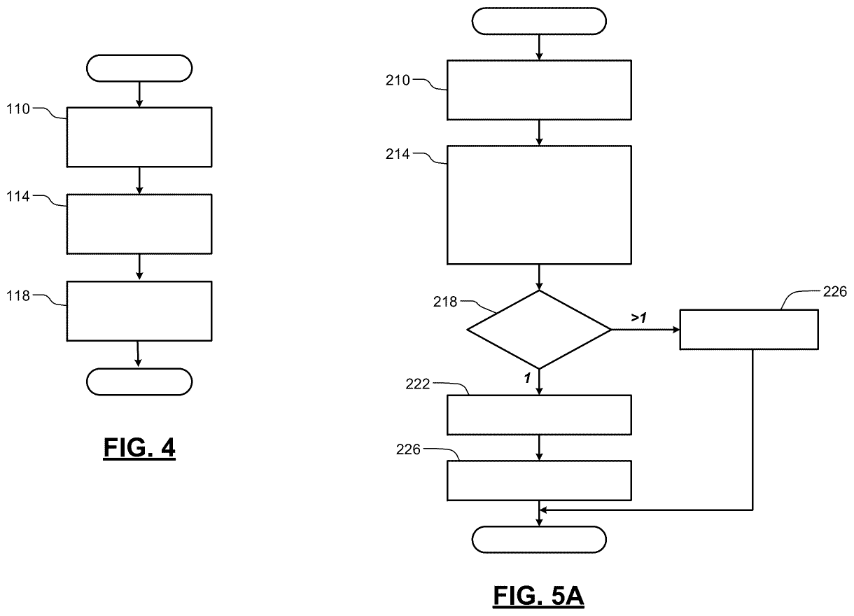

Referring now to FIG. 4, the data association module 48 makes measurements between unassociated measurements (e.g., parking slots in the keyframes that have not been associated) and locations of existing parking slots at 110. At 114, the data association module 48 identifies inter-measurement associations. At 118, the data association module 48 identifies inter-landmark associations.

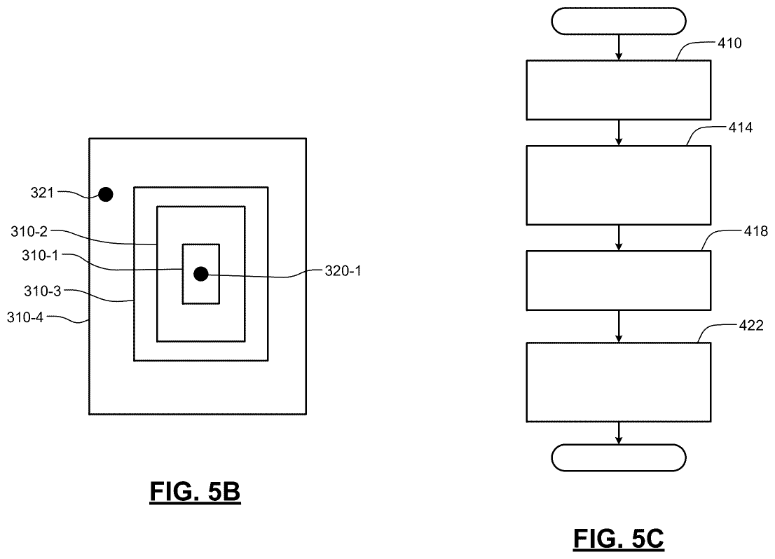

Referring now to FIGS. 5A to 5D, additional details relating to making measurements to existing parking slots (step 110 in FIG. 3) are shown. In FIG. 5A, the data association module 48 focuses on relevant unassociated measurements at 210. Relevant refers to unassociated measurements in a moving window around the vehicle. In other words, the data association module 48 selects images that may relate to a parking slot and that are not already associated with a known parking slot. At 214, the data association module 48 transforms centers of possible parking slots to a local frame and determines the number of candidates with centers falling within a predetermined center zone 320-1. Candidates falling into zones 320-2 and 320-3 are not acceptable since they imply overlapping parking slots, which may lead to a collision. Candidates located in an outer region 310-4 may be associated with other parking slots such as a parking slot 320.

At 218, the data association module 48 determines the number of candidates within the region 320-1. If the data association module 48 determines the number of candidates is equal to one at 218, the data association module 48 considers the candidate as a distinct association at 222 and adds link in the database at 226. If the data association module 48 determines the number of candidates is greater than one at 218, the data association module 48 considers the candidate as a non-distinct association at 222 and adds a database link at 226.

In FIG. 5C, an example of the step 210 is shown. At 410, the newest keyframe from involved states are considered. At 414, all keyframes within a search radius around the newest keyframe are considered. At 418, keyframes that are marked for deletion are ignored. At 422, unassociated measurements from the remaining keyframes are considered.

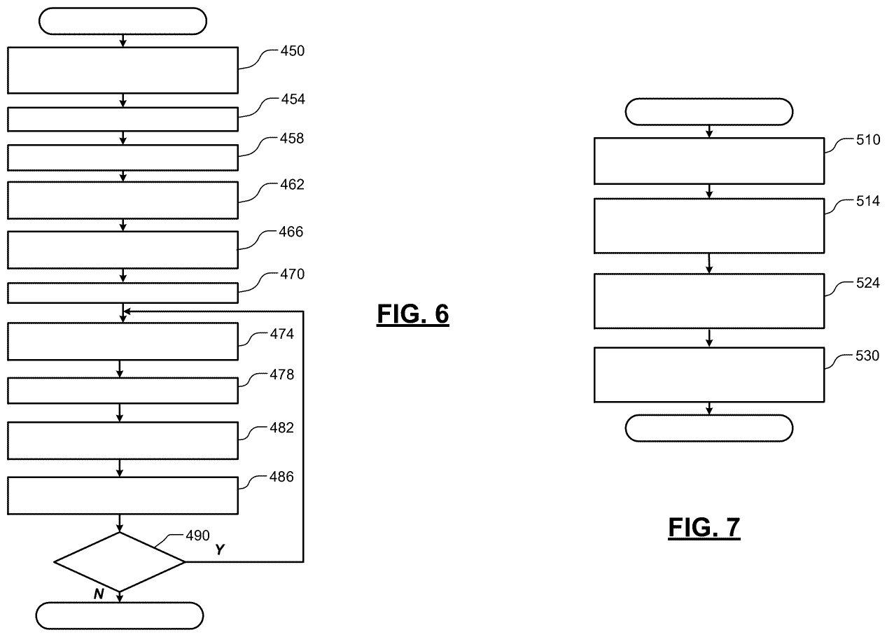

Referring now to FIG. 6, steps performed by the data association module 48 when identifying inter-measurement associations are shown. At 450, the method focuses on relevant unassociated measurements. At 454, the method creates new states. At 458, the method transforms/rotates measurements to a map. At 462, the method calculates distances between measurements. At 466, the method clusters measurements that are within a predetermined distance of one another using distances.

At 470, the method selects a first cluster. At 474, the method calculates initial estimates for the parking slot. At 478, the method adds a landmark or parking slot to the database. At 482, the method links measurements to the landmark/parking slot in the database. At 486, the method denotes the first keyframe in the cluster as a reference. At 490, the method determines whether there is another cluster. If true, the method returns to 474. If false, the method ends.

Referring now to FIG. 7, steps for calculating distances between measurements are performed. At 510, distances between parking slot features such as centers or corners are calculated. At 514, distances between swapped slot corners are calculated (with 180° shift). The maximum corner distance is determined for regular and swapped orientations at 524. At 530, the minimum distance between regular and swapped is selected.

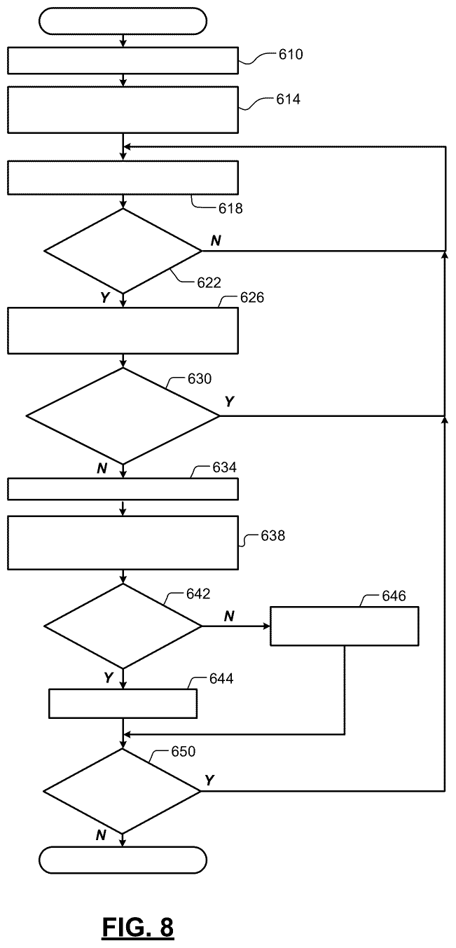

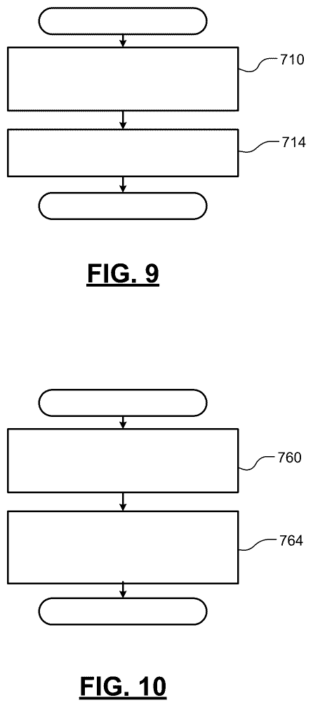

Referring now to FIGS. 8 to 10, steps performed by the data association module 48 when identifying inter-landmark associations 118 (FIG. 4) are shown. In FIGS. 8 and 9, the method retrieves existing associations at 610. In FIG. 9, an example of extracting existing associations is shown. At 710, the method retrieves database links of neighboring parking slots and with the parking slot identification (id). At 714, the method determines the missing connection (e.g., right hand side (RHS) or left hand side (LHS)).

Returning to FIG. 8, the method extracts all candidate parking slots from the database for association at 614. In FIG. 10, an example of extracting all candidate parking slots from the database for association at 614 is shown. In FIG. 10, the parking slots already associated to the current slot are excluded at 760. At 764, the parking slots located outside a region (e.g., a window) around the current parking slot are excluded.

Referring back to FIG. 8, the method selects one of the candidate parking slots at 618. At 622, the method determines whether the neighboring parking slot orientation matches. If 622 is false, the method returns to 618. If 622 is true, the method transforms the candidate to current slot coordinates at 626. At 630, the method determines whether the candidate already has a neighbor (e.g., front (F) (for parallel parking slot situations), rear (R), left hand side (LHS), and/or right hand side (RHS)). If 630 is true, the method returns to 618. If 630 is false, the method stores as valid candidate for neighbor association at 634 (and the location such as F, R, LHS, RHS). At 638, the method selects best candidates for neighbor parking slots based on a predetermined minimum distance.

At 642, the method determines whether the parking slot has matching neighbor parking slots. If 642 is true, the method updates database links at 644. If 642 is false, the method does not update the database links at 646. If there is another candidate parking slot as determined at 650, the method returns to 618.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A vision-based perception system for a vehicle, comprising:
N cameras arranged on the vehicle and configured to generate a plurality of images, where N is an integer greater than one;
an image analysis module configured to identify a plurality of features of parking slots in the plurality of images and to generate a plurality of keyframe measurements based thereon;
a keyframe selecting module configured to identify selected ones of the plurality of keyframe measurements;
a database configured to receive the selected ones of the plurality of keyframe measurements and to selectively output unassociated keyframe measurements and existing features of parking slots within a predetermined range of the vehicle; and
a data association module configured to receive the unassociated keyframe measurements and the existing features of parking slots from the database.

2. The vision-based perception system of claim 1, wherein at least two of the unassociated keyframe measurements and the existing features of parking slots are a-synchronous measurements.

3. The vision-based perception system of claim 2, wherein the data association module is configured to selectively associate selected ones of the keyframe measurements to existing features of parking slots and other selected ones of the keyframe measurements to new features of parking slots.

4. The vision-based perception system of claim 1, wherein the data association module is configured to:
generate measurements between the unassociated keyframe measurements and the existing features of parking slots;
identify inter-measurement associations; and
identify inter-landmark associations.

5. The vision-based perception system of claim 4, wherein the data association module is configured to generate measurements between the unassociated keyframe measurements and the existing features of parking slots by transforming features of parking slots of the unassociated keyframe measurements to a local frame and calculating a distance to the existing features of parking slots.

6. The vision-based perception system of claim 5, wherein when the distance is less than a predetermined distance, the data association module is configured to define a distinct association between a corresponding one of the unassociated keyframe measurements and a corresponding one of the existing features of parking slots.

7. The vision-based perception system of claim 4, wherein the data association module is configured to identify inter-measurement associations by:
calculating distances between the unassociated keyframe measurements; and
clustering the unassociated keyframe measurements based on the distances into one or more clusters.

8. The vision-based perception system of claim 7, wherein the data association module is configured to identify inter-measurement associations by:
selecting one of the one or more clusters;
calculating an initial estimate for a parking slot corresponding to the one of the one or more clusters;
adding the parking slot to the database; and
repeating the calculating and adding for remaining ones of the one or more clusters.

9. The vision-based perception system of claim 4, wherein the data association module is configured to identify inter-landmark associations by:
retrieving existing neighbor associations;
retrieving relevant parking slots from the database;
selecting a candidate parking slot; and
determining whether orientations of neighbor parking slots match the candidate parking slot.

10. The vision-based perception system of claim 9, wherein the data association module is configured to identify inter-landmark associations by:
selecting a best candidate from two or more candidates as a neighbor if the candidate parking slot does not already have a neighboring parking slot in a predetermined neighbor location;
updating association links in the database; and
repeating the selecting and updating for other candidate parking slots.

11. The vision-based perception system of claim 10, wherein the data association module is configured to select the best candidate from the two or more candidates based on distances between the two or more candidates and the candidate parking slot.

12. A method for identifying and associating parking slots, comprising:
generating a plurality of images using N cameras arranged on a vehicle, where N is an integer greater than one;
identifying a plurality of features of parking slots in the plurality of images and to generating a plurality of keyframe measurements based thereon;
identifying selected ones of the plurality of keyframe measurements;
storing the selected ones of the plurality of keyframe measurements in a database;
selecting unassociated keyframe measurements and existing features of parking slots within a predetermined range of the vehicle from the database; and
selectively associating selected ones of the keyframe measurements to existing features of parking slots and other selected ones of the keyframe measurements to new features of parking slots,
wherein at least two of the unassociated keyframe measurements and the existing features of parking slots are a-synchronous measurements.

13. The method of claim 12, wherein selectively associating selected ones of the keyframe measurements to existing features of parking slots and other selected ones of the keyframe measurements to new features of parking slots includes:
generating measurements between the unassociated keyframe measurements and the existing features of parking slots;
identifying inter-measurement associations; and
identifying inter-landmark associations.

14. The method of claim 13, wherein generating measurements between the unassociated keyframe measurements and the existing features of parking slots includes transforming features of parking slots of the unassociated keyframe measurements to a local frame and calculating a distance to the existing features of parking slots.

15. The method of claim 14, wherein when the distance is less than a predetermined distance, defining a distinct association between a corresponding one of the unassociated keyframe measurements and a corresponding one of the existing features of parking slots.

16. The method of claim 13, wherein identifying the inter-measurement associations includes:
calculating distances between the unassociated keyframe measurements; and
clustering the unassociated keyframe measurements based on the distances into one or more clusters.

17. The method of claim 16, wherein performing inter-measurement associations includes:
selecting one of the one or more clusters;
calculating an initial estimate for a parking slot corresponding to the one of the one or more clusters;
adding the parking slot to the database; and
repeating the calculating and adding for remaining ones of the one or more clusters.

18. The method of claim 13, wherein identifying inter-landmark associations includes:
retrieving existing neighbor associations;
retrieving relevant parking slots from the database;
selecting a candidate parking slot; and
determining whether orientations of neighbor parking slots match the candidate parking slot.

19. The method of claim 18, wherein identifying inter-landmark associations includes:
selecting a best candidate from two or more candidates as a neighbor if the candidate parking slot does not already have a neighboring parking slot in a predetermined neighbor location;
updating association links in the database; and
repeating the selecting and updating for other candidate parking slots.

20. A vision-based perception system for a vehicle, comprising:
N cameras arranged on the vehicle and configured to generate a plurality of images, where N is an integer greater than one;
an image analysis module configured to identify a plurality of features of parking slots in the plurality of images and to generate a plurality of keyframe measurements based thereon;
a keyframe selecting module configured to identify selected ones of the plurality of keyframe measurements;
a database configured to receive the selected ones of the plurality of keyframe measurements and to selectively output unassociated keyframe measurements and existing features of parking slots within a predetermined range of the vehicle; and
a data association module configured to receive the unassociated keyframe measurements and the existing features of parking slots from the database,
wherein at least two of the unassociated keyframe measurements and the existing features of parking slots are a-synchronous measurements,
wherein the data association module is configured to selectively associate selected ones of the keyframe measurements to existing features of parking slots and other selected ones of the keyframe measurements to new features of parking slots, and
wherein the data association module is configured to:
generate measurements between the unassociated keyframe measurements and the existing features of parking slots;
identify inter-measurement associations; and
identify inter-landmark associations.
